(19) United States
(12) Patent Application Publication
(10) Pub. No.: US 2026/0249623 A1
(43) Pub. Date: Aug. 27, 2026

(54) PRINTER

(71) Applicants: CITIZEN WATCH CO., LTD., Tokyo (JP); CITIZEN SYSTEMS JAPAN CO., LTD., Tokyo (JP)

(72) Inventors: Akira TAKAHASHI, Tokyo (JP); Naohisa SAWAI, Tokyo (JP)

(21) Appl. No.: 18/992,495

(22) PCT Filed: Jun. 26, 2023
(86) PCT No.: PCT/JP2023/023518

§ 371 Date: Jan. 8, 2025

(30) Foreign Application Priority Data
Jul. 21, 2022 (JP) 2022-116431

(51) Int. Cl. B41J 11/00; B41J 15/04

(52) U.S. Cl. CPC B41J 11/0055; B41J 15/046

(57) ABSTRACT

A printer includes a feeding path, a reversing roller, a gripping roller, and a pair of left and right guide members. The guide member is formed of an upstream first portion and a downstream second portion. The first portions are formed to have a spacing that narrows gradually in a sending direction, such that their sections closest to the reversing roller have a spacing wider than the width of a paper and that their sections closest to the second portions have a spacing substantially equal to the width. The second portions are formed to be substantially parallel to have the spacing substantially equal to the width. The printer includes a second cam that retracts the reversing roller in a state in which the front end of the paper has reached the downstream portion, and a first cam that moves a movable guide member.

### CROSS-REFERENCE TO RELATED APPLICATION

The present application is based upon and claims the benefit of priority from Japanese Patent Application No. 2022-116431 filed to the Japan Patent Office on Jul. 21, 2022, the entire disclosure of which is incorporated in its entirety in the present specification by reference.

### TECHNICAL FIELD

The present disclosure relates to a printer.

### BACKGROUND

A printer, which prints on paper cut to a predetermined length (sheet paper (cut paper)), sends the paper one sheet at a time to a transport path by a drive roller. The transport path extends from a paper storage section, where the paper is stored, to an outlet, where the paper is discharged, through a printing section to print on the paper. The paper is sent along the transport path by a sequential passing to a plurality of drive rollers provided on the transport path (see, for example, Patent Document 1: JP 5987688).

Here, while the paper is sent by the drive rollers, the paper may meander due to the posture change or the sending direction change. If the paper meanders, a part of the paper may deviate from the region of the transport path where the paper is supposed to pass, thereby causing a misprinting on the paper or a paper jamming inside the printer.

Thus, some printers include a meandering correction mechanism that corrects the meandering of the paper by tapping at least one side edge of the paper, which is sent along the transport path, from the outside in the width direction of the paper.

The above-mentioned meandering correction mechanism is, however, composed of many components, thereby complicating the structure and increasing costs.

The present disclosure has been made in view of the above situation, and its object is to provide a printer that can correct the meandering of paper, while preventing paper jamming, with a simple structure having a small number of components.

The present disclosure provides a printer including a transport path that a sheet paper passes therethrough; a drive roller that sends the sheet paper along the transport path, the drive roller being provided in an upstream region in a sending direction of the sheet paper of the transport path; a downstream roller that is provided downstream in the sending direction of the transport path, the downstream roller restraining the sheet paper that has passed through the transport path; and a pair of guide members that are disposed outside of both side edges of the sheet paper passing through the transport path to guide the sheet paper by limiting positions of both side edges of the sheet paper, wherein each of the pair of guide members comprises a first portion positioned upstream in the sending direction and a second portion positioned downstream therein, wherein a spacing between the pair of guide members is wider than a width of the paper at sections of the first portions, which are closest to the drive roller, narrows gradually in the sending direction of the paper, is formed to be equal to the width of the sheet paper at sections of the first portions, which are closest to the second portions, and is formed to be equal to the width of the sheet paper at the second portions, wherein, when an area between the drive roller and the second portions is halved into a first region upstream in the sending direction and a second region downstream therein, the sections of the first portions, which are closest to the drive roller, are disposed to be positioned in the first region, wherein the transport path has a space extending in a thickness direction of the sheet paper, such that the space can accommodate a bent portion of the sheet paper in a mountain-like raised state between a front end portion of the sheet paper, of which direction has been corrected due to a limitation by the second portions, and a rear end portion of the sheet paper, which has been restricted by the drive roller.

BRIEF DESCRIPTION OF DRAWINGS

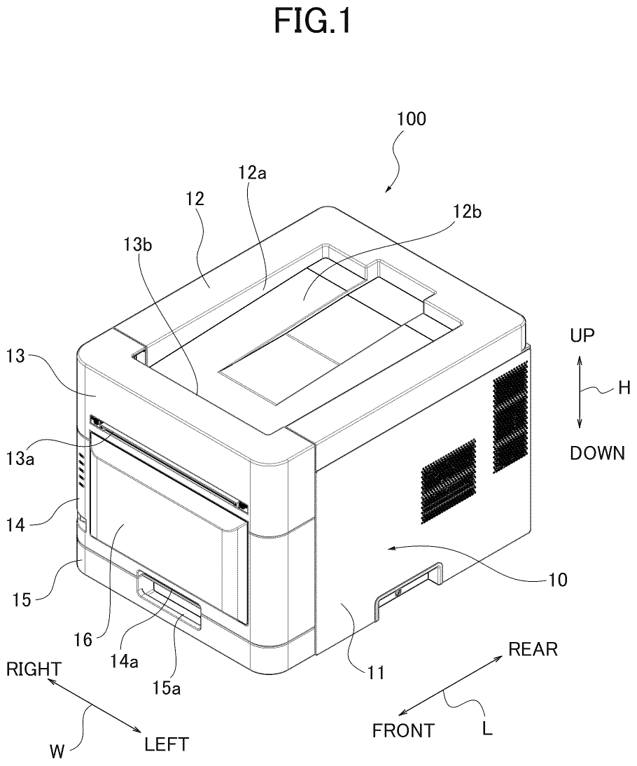

FIG. 1 is a perspective view showing an external appearance of a dye-sublimation thermal printer (hereinafter, referred to as printer).

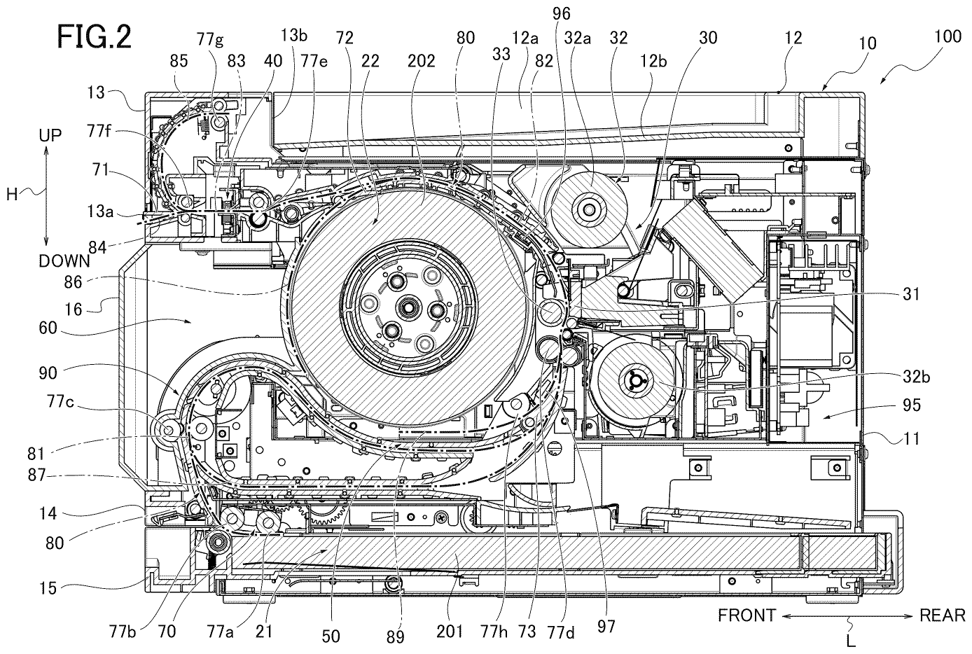

FIG. 2 is a cross-sectional view taken by a vertical plane that is along a front-rear direction L and passes the center in the width direction W of the printer.

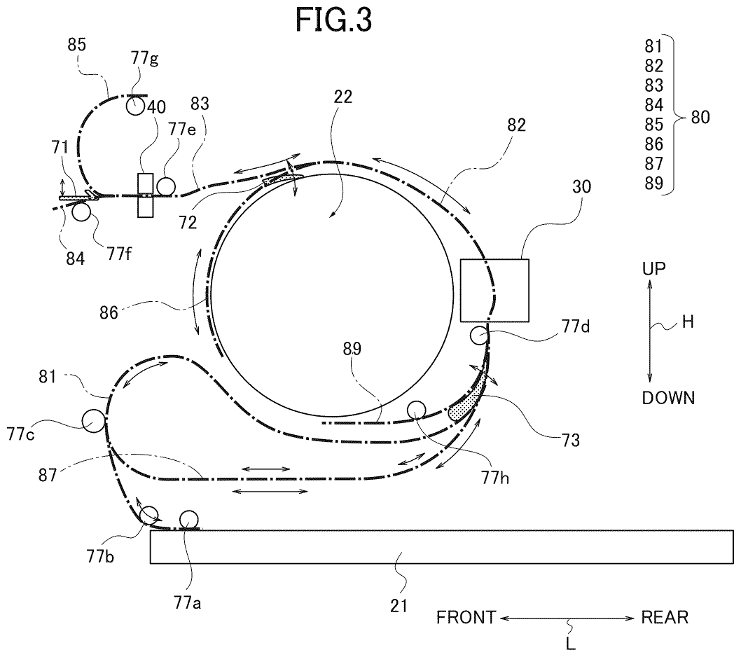

FIG. 3 is a schematic view that is schematically shown by simplifying FIG. 2, for clarifying a transport path shown in FIG. 2.

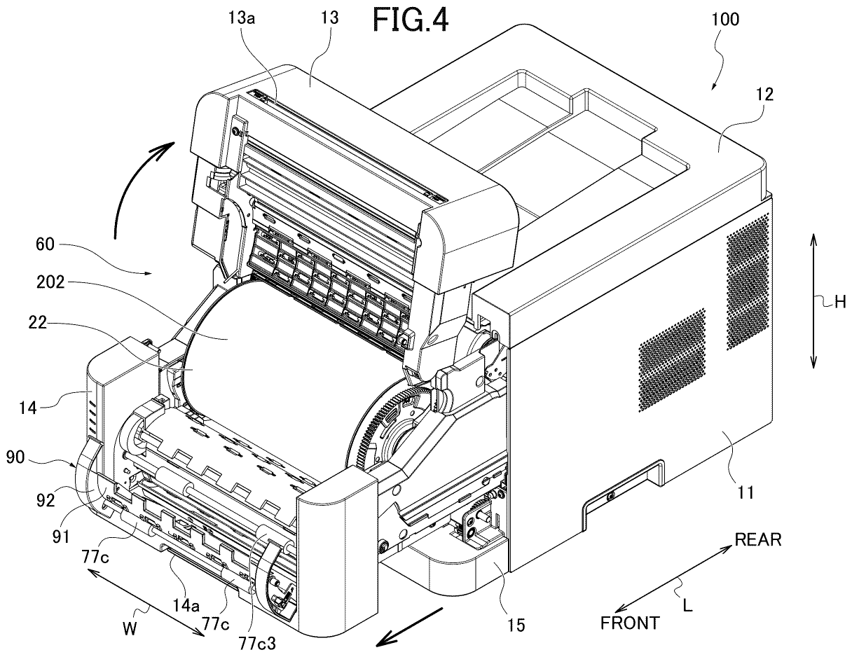

FIG. 4 is a perspective view showing a condition in which a front upper cover of the printer has been opened and a roll-paper storage section has been pulled forward in the front-rear direction L.

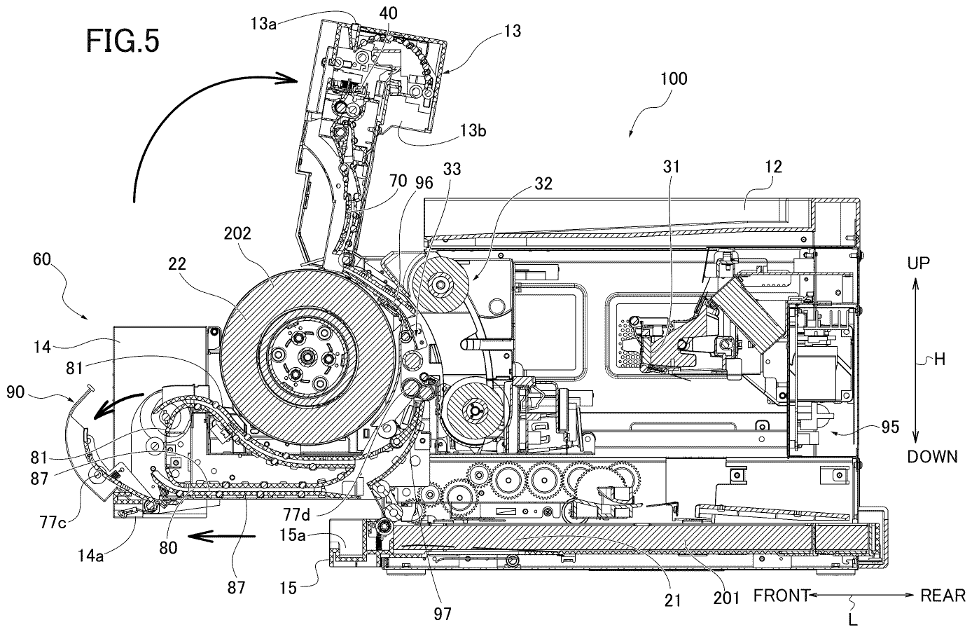

FIG. 5 is a sectional view of the condition shown in FIG. 4, corresponding to FIG. 2.

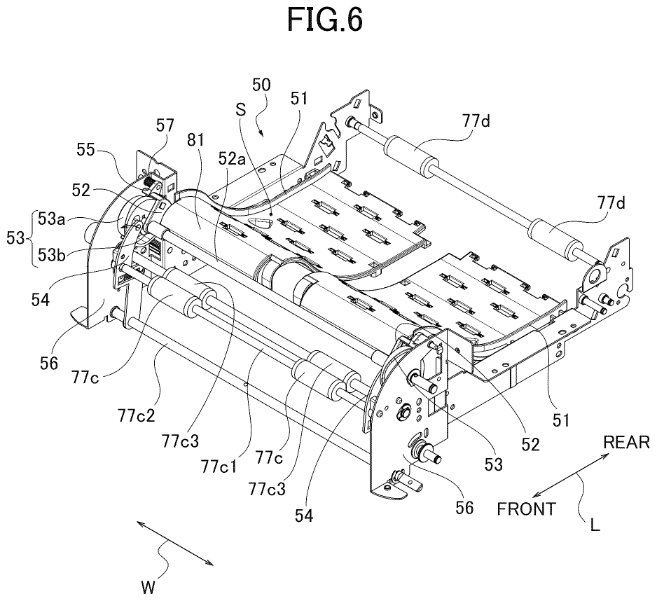

FIG. 6 is a perspective view showing a condition before correcting the meandering of the paper.

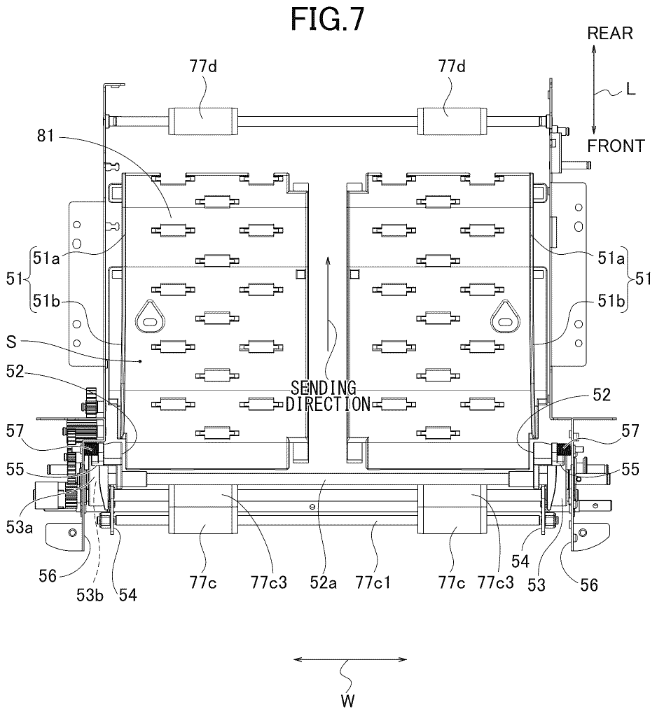

FIG. 7 is a plan view showing the condition before correcting the meandering of the paper.

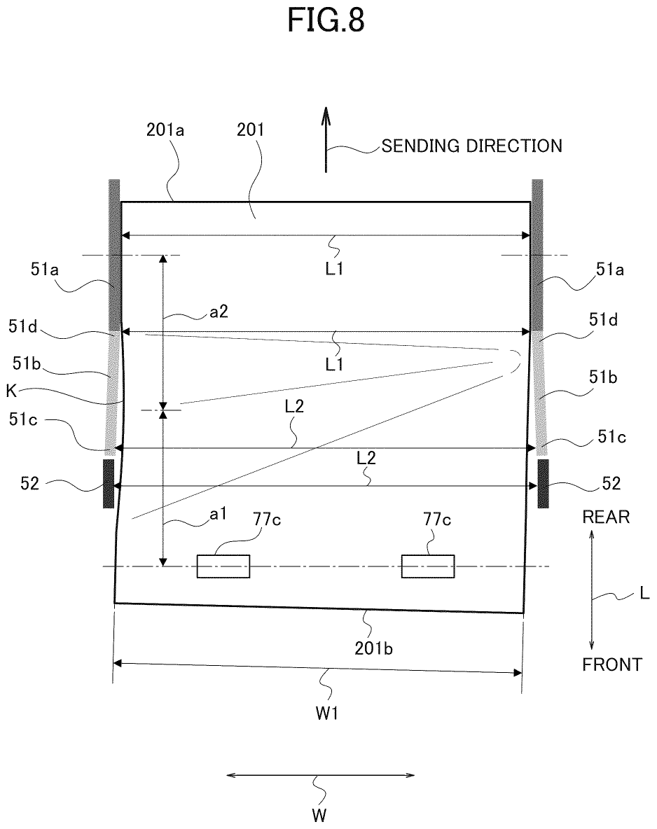

FIG. 8 is a schematic view of FIG. 7, showing the condition before correcting the meandering of the paper.

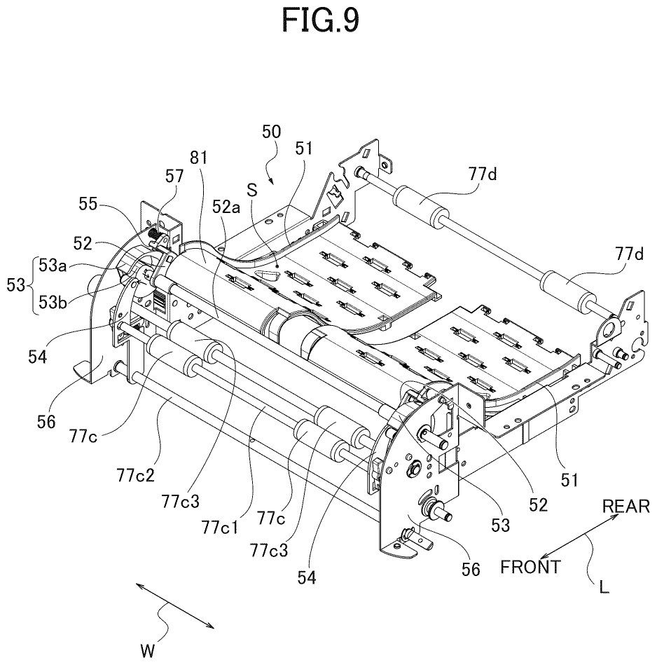

FIG. 9 is a perspective view showing a condition in which the meandering of paper is being corrected, corresponding to FIG. 6.

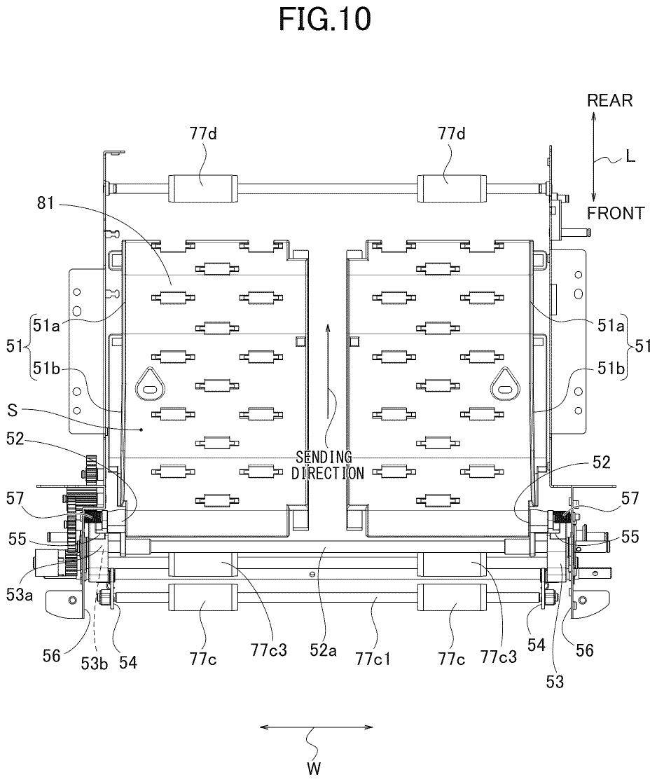

FIG. 10 is a plan view showing the condition in which the meandering of paper is being corrected, corresponding to FIG. 7.

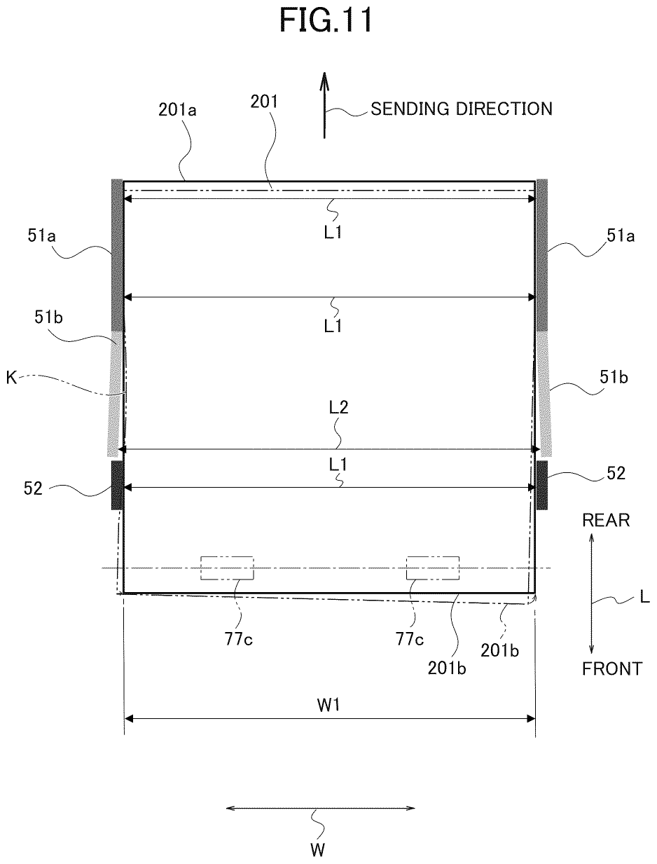

FIG. 11 is a schematic view of FIG. 10, showing the condition in which the meandering of paper is being corrected.

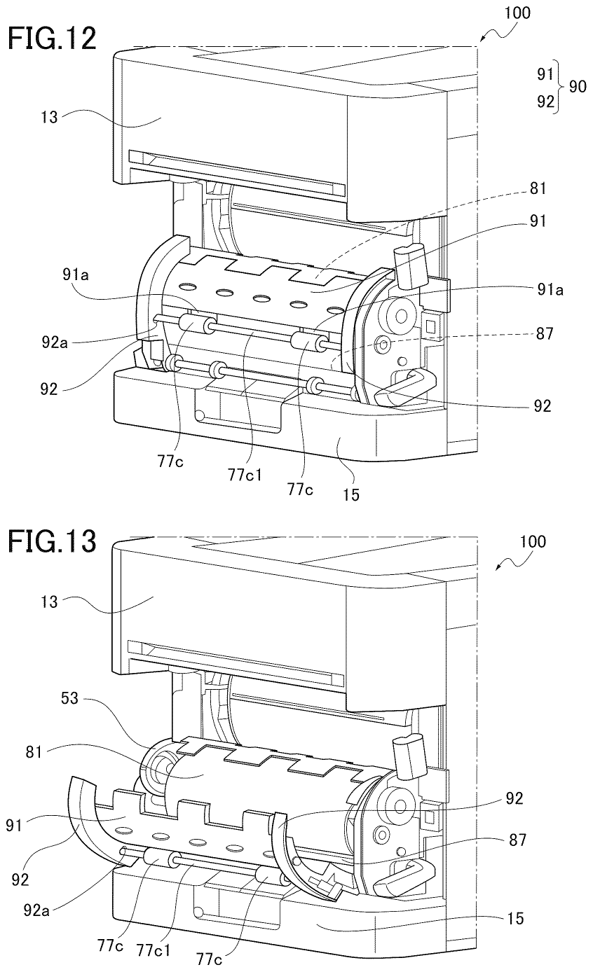

FIG. 12 is a perspective view of a major part, showing a condition in which a paper guide is closed.

FIG. 13 is a perspective view of the major part, showing a condition in which the paper guide is opened.

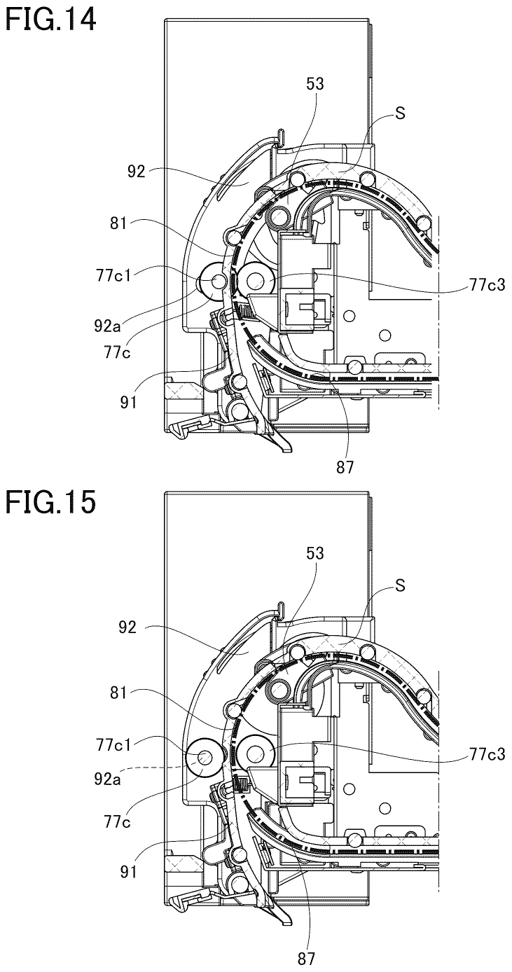

FIG. 14 is a sectional view of a major part, showing a condition in which the paper guide is closed and reversing rollers are in contact with the paper.

FIG. 15 is a sectional view of the major part, showing a condition in which the paper guide is closed and the reversing rollers are away from the paper.

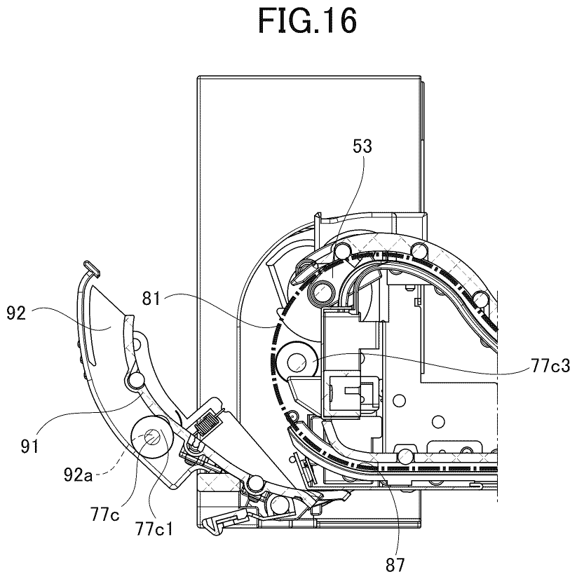

FIG. 16 is a sectional view of the major part, showing a condition in which the paper guide is opened.

### DETAILED DESCRIPTION

An embodiment of the printer according to the present disclosure will be described in the following with reference to the drawings.

FIG. 1 is a perspective view showing an external appearance of a dye-sublimation thermal printer 100 (hereinafter, referred to as printer 100). FIG. 2 is a cross-sectional view taken by a vertical plane that is along a front-rear direction L and passes the center in the width direction W of the printer 100. FIG. 3 is a schematic view that is schematically shown by simplifying FIG. 2, for clarifying a transport path 80 shown in FIG. 2. FIG. 4 is a perspective view showing a condition in which a front top cover 13 of the printer 100 has been opened and a roll-paper storage section 22 has been pulled forward in the front-rear direction L. FIG. 5 is a sectional view of the condition of FIG. 4, corresponding to FIG. 2.

The printer 100 shown in the drawings refers to one embodiment of the printer according to the present disclosure.

The printer 100 includes a case 10, a sheet-paper storage section 21, a roll-paper storage section 22, a printing section 30, a cutter section 40, a transport means 70, a transport path 80, and a meandering correction mechanism 50.

(Case) As shown in FIG. 1, the case 10 includes a case body 11, a top cover 12, a front top cover 13, a front center cover 14, and a front bottom cover 15. The case body 11 is formed to cover mainly both side surfaces in the width direction W and a rear surface in the front-rear direction L.

The top cover is disposed to close a top opening in a height direction H of the case body 11 and is formed with a stacker 12a in which a sheet paper 201 (hereinafter, also simply referred to as paper 201) or a paper 203 unwound from a roll paper 202 is stored.

As shown in FIG. 2, a bottom surface 12b of the stacker 12a is formed in an inclined manner to become lower from the rear toward the front, and the paper 201, 203, which has been discharged rearward from an upper outlet 13b of the front top cover 13, is stored on the front side due to the inclination of the bottom surface 12b.

The front top cover 13 is disposed at the top of the front surface of the printer 100, a front bottom cover 15 is disposed at the bottom of the front surface of the printer 100, and a front center cover 14 is disposed between the front top cover 13 and the front bottom cover 15 on the front surface of the printer 100.

The front center cover 14 includes a detachable trash box 16. The trash box 16 is disposed below the aforementioned cutter section 40 and is a section to receive cut pieces produced when the paper 201, 203 is cut by the cutter section 40. The trash box 16 is attached to the front center cover 14 to be detachable therefrom by an upward sliding relative to the front center cover 14. FIGS. 4 and 5 show a condition in which the trash box 16 has been removed.

As shown in FIGS. 4 and 5, the front top cover 13 and the front center cover 14 are provided in an internal drawer unit 60 (one example of a drawer unit). The internal drawer unit 60 is housed within the space enclosed by the case body 11 and the top cover 12, and can be pulled forward relative to the case body 11 and the top cover 12 by placing a finger on a fingerhold 14a at the bottom of the front center cover 14 and pulling it forward in the front-rear direction L.

The internal drawer unit 60 includes, in an integral manner, the roll-paper storage section 22, an ink ribbon 32, and a platen roller 33 of the printing section 30, the cutter section 40, the transport means 70, the transport path 80, and the meandering correction mechanism 50, as well as the front top cover 13 and the front center cover 14.

The front top cover 13 is supported to be rotatable in the upper rearward direction shown with the arrows in FIGS. 4 and 5, in a condition that the internal drawer unit 60 has been pulled forward from the space enclosed by the case body 11 and the top cover 12 as shown in FIGS. 4 and 5, from a condition that the front top cover 13 is closed as shown in FIG. 1. When the front top cover 13 is opened by the upper rearward rotation, it opens parts of the front and top of the roll-paper storage section 22. This exposes the roll-paper storage section 22 inside the case 10, enabling the roll paper 202 to be placed into or removed from the roll-paper storage section 22.

The front top cover 13 includes a front outlet 13a on its front surface and an upper outlet on its rear surface. The front outlet 13a is configured to discharge the printed paper 201, 203 forward. The upper outlet is configured to discharge the printed paper 201, 203 rearward into the stacker on the top cover 12.

As shown in FIGS. 2 and 5, the front bottom cover 15 is formed as a part on the front surface of the sheet-paper storage section 21 having a tray shape. In other words, the front bottom cover 15 is a part of the sheet-paper storage section 21.

(Sheet-paper Storage Section) As shown in FIG. 2, the sheet-paper storage section 21 is provided at the bottom of the printer 100 below the roll-paper storage section 22. The sheet-paper storage section 21 stores the sheet papers 201 that have been cut to predetermined sizes and stacked in the thickness direction.

The sheet-paper storage section 21 is provided to be pulled forward relative to the case body 11 and the top cover 12 independently of the internal drawer unit 60 by placing a finger on a fingerhold 15a formed on an upper part of the front bottom cover 15 and pulling the sheet-paper storage section 21 forward in the front-rear direction L. The sheet-paper storage section 21 has an open top when pulled forward relative to the case body 11 and the top cover 12, allowing the sheet papers 201 stored inside to be taken in or out through the open top.

(Roll-paper Storage Section) As mentioned above, the roll-paper storage section 22 is formed in the internal drawer unit 60. The roll-paper storage section 22 is a section to store the roll paper 202 prepared by rolling the elongated paper 203. As shown in FIGS. 2, 4, and 5, the roll-paper storage section 22 stores the roll paper 202 in an orientation in which the axis of the roll paper 202 is parallel with the width direction W of the printer 100.

The roll-paper storage section 22 is positioned above the sheet-paper storage section 21 when the internal drawer unit 60 is housed within the case 10 as shown in FIG. 2. In FIG. 2, the roll paper 202 is disposed to rotate counterclockwise as the paper 203 is pulled and unwound from the lower end of the roll paper 202 in the right direction shown in the drawing.

(Printing Section) The printing section 30 is disposed behind the roll-paper storage section 22. Under the control of a controller 95 of the printer 100, the printing section 30 prints on the paper 201, 203 as it passes through a section (the aforementioned printing path 82) of the transport path 80, which extends substantially vertically behind the roll-paper storage section 22.

The printing section 30 includes a thermal head 31, the ink ribbon 32, and the platen roller 33. The ink ribbon 32 transfers the ribbon from a delivery roll 32a to a winding roll 32b in synchronization with the transport of the paper 201, 203, and the sublimation dye applied to the ribbon is transferred onto the paper 201, 203 through diffusion, as a result of the heat generated by the thermal head 31 in contact with the ribbon, thereby printing on the paper 201, 203.

The ink ribbon 32 is provided in the internal drawer unit 60. As shown in FIGS. 4 and 5, when the internal drawer unit 60 is pulled forward from the case body 11, the ink ribbon 32 can be drawn forward along an arcuate path above the roll-paper storage section 22, thereby allowing for easy replacement of the ink ribbon 32.

A platen roller 33 is disposed on the opposite side of the ink ribbon 32 and the thermal head 31 across the paper 201, 203. The platen roller 33 presses the paper 201, 203 against the thermal head 31, with the ribbon in between.

(Cutter Section) The cutter section 40 is disposed ahead of the roll-paper storage section 22 and inside the front top cover 13. Under the control of the controller 95 of the printer 100, the cutter section 40 cuts the paper 201, 203 in the width direction W passing through a part (the aforementioned discharge path 83) of the transport path 80, which extends forward from above the roll-paper storage section 22. The cut pieces of the paper 201 fall into the trash box 16 disposed below the cutter section 40 and are stored there.

(Transport Path) The transport path 80 is a passage through which the paper 201, 203 is transported. Firstly, a part of the transport path 80 through which the paper 201 is transported will be described.

As shown by a single-point chain line in FIGS. 2 and 3, the part of the transport path 80 where the sheet paper 201 is transported includes a feeding path 81, the printing path 82, the discharge path 83, the front discharge path 84, the upper discharge path 85, the printing upstream path 86, and a printing downstream path 87.

The feeding path 81 extends upward from the front end of the sheet-paper storage section 21 and turns back rearward and downward in a space in front of the roll-paper storage section 22 and behind the front center cover 14. Then, the feeding path 81 extends below the roll-paper storage section 22 and above the sheet-paper storage section 21 toward the rear of the roll-paper storage section 22, and then upwardly extends to a position at the rear of the roll-paper storage section 22.

As mentioned hereinafter, the feeding path 81 has a space S extending in the thickness direction of the paper 201 such that, even when the sheet paper 201 in transportation is raised in a mountain-like shape in the thickness direction, it is allowed to pass therethrough without catching a bent portion K of the paper 201 in such mountain-like raised state.

The printing path 82 follows the feeding path 81, extends at the rear of the roll-paper storage section 22 in a manner to rise upwardly along the rear of the roll-paper storage section 22, and extends forward above the roll-paper storage section 22 until it reaches a front part above the roll-paper storage section 22. The printing section 30 is disposed at the printing path 82.

The discharge path 83 follows the printing path 82 and extends forward from the front part above the roll-paper storage section 22 along the front-rear direction L. The cutter section 40 is disposed at the discharge path 83. The discharge path 83 extends forward of the cutter section 40.

The front discharge path 84 follows the discharge path 83 and extends forward to the front outlet 13a. The upper discharge path 85 follows the discharge path 83 and extends in a curved manner upward and rearward to reach the upper discharge outlet 13b.

At a separation point between the front discharge path 84 and the upper discharge path 85, a discharge-path switching member 71 is provided to switch the movement of the paper 201, 203, which has traveled forward in the discharge path 83, either to travel to the upper discharge path 85 or the front discharge path 84.

The printing upstream path 86 follows the printing path 82 and extends from the front part above the roll-paper storage section 22, curving concentrically around the outer periphery of the roll-paper storage section 22, and continues downward below the roll-paper storage section 22 to a position just before reaching the feeding path 81. The printing upstream path 86 is a pathway into which the paper 201 is pulled before being transported to the printing path 82 and printed in the printing section 30. The aforementioned printing downstream path 87 is a pathway to which the paper 201 is transported after being transported to the printing path 82 and printed in the printing section 30.

In other words, a part of the paper 201 that has not yet been printed passes through the printing upstream path 86, and a part of the paper 201 that has already been printed passes through the printing downstream path 87.

At a separation point between the printing upstream path 86 and the discharge path 83, the printing-discharge switching flap 72 is provided. The printing-discharge switching flap 72 is rotatably configured so that its tip moves up and down under the control of the controller 95. In the condition shown in FIG. 2, the printing-discharge switching flap 72 has its tip positioned downward. As a result, the paper 201 that has traveled forward in the printing path 82 is redirected to the discharge path 83. On the other hand, when the tip of the printing-discharge switching flap 72 is positioned upward, the paper 201 that has traveled forward in the printing path 82 is redirected to the printing upstream path 86.

The printing downstream path 87 follows an end portion of the printing path 82 on the side of the feeding path 81. The printing downstream path 87 extends from the rear to the front of the roll-paper storage section 22, passing below the roll-paper storage section 22 and the feeding path 81, and above the sheet-paper storage section 21. The leading end of the printing downstream path 87 on the front side rises upwardly and smoothly connects to the feeding path 81, which similarly extends upward.

The paper 201 is printed on the surface that comes into contact with the ink ribbon 32 in the printing path 82, that is, on the surface facing rearward in the front-rear direction L as shown in FIGS. 2 and 3. When the paper 201 is transported to the printing downstream path 87, the printed surface faces downward in the height direction H.

When the paper 201 is transported forward in the printing downstream path 87 and then enters the feeding path 81, which extends upward, the printed surface faces upward in the height direction H, below the roll-paper storage section 22.

Furthermore, when the paper 201 is transported rearward in the feeding path 81 and then in the printing path 82 extending upward, the printed surface faces forward in the front-rear direction. In other words, the paper 201 is transported in the feeding path 81 after the printing downstream path 87 joins the feeding path 81, thereby inverting its front and back sides. Therefore, the pathway from the printing downstream path 87 to the feeding path 81, including the feeding path 81, forms a reversing path that reverses the front and back surfaces of the paper 201 after printing on the front surface.

Next, a part of the transport path 80 for the paper 203 unwound from the roll paper 202 will be described. As shown by a single-point chain line in FIGS. 2 and 3, the part of the transport path 80, where the paper 203 is unwound from the roll paper 202 is transported, includes a roll-paper feeding path 89, in addition to the above-mentioned part where the sheet paper 201 is transported.

The roll-paper feeding path 89 extends rearward from substantially the bottom of the roll paper 202, which is stored in the roll-paper storage section 22, to an upwardly raised position at the rear of the roll-paper storage section 22.

At a part where the feeding path 81 and the roll-paper feeding path 89 join, a feeding switching flap 73 is provided. The feeding switching flap 73 is rotatably provided to displace its tip forward and rearward. In a condition shown in FIG. 2, the tip of the feeding switching flap 73 is biased toward the front side by a spring, which is omitted from the drawings, such that the paper 201 transported through the feeding path 81 travels to the printing path 82 and that the paper 201 transported from the printing path 82 travels to the printing downstream path 87.

On the other hand, when the paper 203 unwound from the roll paper 202 and transported through the roll-paper feeding path 89 travels toward the printing path 82, the paper 203 presses the feeding switching flap 73 against the biasing force of the spring towards the rear side, thereby traveling to the printing path 82.

When the paper 203 unwound from the roll paper 202 is printed at the printing section 30 of the printing path 82, the paper 203 remains unseparated from the roll paper 202. Therefore, the feeding switching flap 73 remains pressed toward the rear side in a displaceable range of the tip by a part of the paper 203 passing through the roll-paper feeding path 89.

(Transport Means) The transport means 70 includes a sheet-paper delivery roller 77a, a feeding roller 77b, a reversing roller 77c, a gripping roller 77d, a sending roller 77e, a first discharge roller 77f, a second discharge roller 77g, and a roll-paper delivery roller 77h. These transport rollers 77a to 77h are driven, for example, by a single motor, but may be separately driven by at least two motors.

Each of these transport rollers 77a to 77h comes into contact with the front or back surface of at least one of the sheet paper 201 and the paper 203, and rotates under the control of the controller 95, thereby transporting the paper 201, 203 along the transport path 80.

The sheet-paper delivery roller 77a is disposed above and near a front-end portion of the sheet-paper storage section 21. The sheet-paper delivery roller 77a comes into contact with the topmost sheet paper 201 of the stored sheet paper 201 in the sheet-paper storage section 21 and rotates to deliver the sheet paper 201 to the feeding path 81. The sheet-paper delivery roller 77a rotates in a direction opposite to the delivery direction so that the sheet paper 201 delivered to the feeding path 81 is pulled back into the sheet-paper storage section 21.

The feeding roller 77b is disposed at a position of the feeding path 81 close to the sheet-paper delivery roller 77a. The feeding roller 77b comes into contact with the sheet paper 201, which has been delivered to the feeding path 81 by the sheet-paper delivery roller 77a, and transports the sheet paper 201 upward along the feeding path 81. The feeding roller 77b also rotates in a direction opposite to the above-mentioned transport direction, thereby pulling the sheet paper 201 backward.

The reversing roller 77c, the gripping roller 77d, the sending roller 77e, the first discharge roller 77f, the second discharge roller 77g, and the roll-paper delivery roller 77h, which will be described in the following, also rotate in directions opposite to their transport directions, similar to the feeding roller 77b, thereby pulling the sheet paper 201 backward.

The reversing roller 77c is disposed at a part of the feeding path 81 above the feeding roller 77b. The reversing roller 77c comes into contact with the sheet paper 201 that has traveled in the feeding path 81 by the feeding roller 77b and transports the sheet paper 201 along the feeding path 81 towards the printing path 82.

The gripping roller 77d is disposed at a part of the printing path 82 that is on the side close to the feeding path 81 and at a position that is ahead of the tip of the feeding switching flap 73. The gripping roller 77d comes into contact with the sheet paper 201, which has been transported to the printing path 82, and transports the sheet paper 201 through the printing section 30 towards the discharge path 83 or the printing upstream path 86. At this time, the feeding switching flap 73 has been switched forward, thereby allowing the sheet paper 201 transported through the feeding path 81 to proceed to the printing path 82.

The sending roller 77e is disposed at a part of the discharge path 83 closer to the printing path 82 than the cutter section 40. The sending roller 77e comes into contact with the sheet paper 201, which has been transported to the discharge path 83, and transports the sheet paper 201 to the first discharge roller 77f through the cutter section 40.

The first discharge roller 77f is disposed near an end portion of the discharge path 83 that is on a far side from the printing path 82 and at a position before the discharge-path switching member 71. The first discharge roller 77f comes into contact with the sheet paper 201, which has been transported to the discharge path 83, and transports the sheet paper 201 to the front discharge path 84 or the upper discharge path 85 depending on the position of the discharge-path switching member 71.

The second discharge roller 77g is disposed close to the upper outlet 13b of the upper discharge path 85. The second discharge roller 77g comes into contact with the sheet paper 201, which has been transported to the upper discharge path 85, and discharges the sheet paper 201 from the upper outlet 13b into the stacker 12a of the top cover 12.

The roll-paper delivery roller 77h is disposed at a part of the roll-paper feeding path 89 that is on the side close to the printing path 82 and at a position before the tip of the feeding switching flap 73. The roll-paper delivery roller 77h comes into contact with the paper 203, which is wound around the outermost circumference of the roll paper 202 stored in the roll-paper storage section 22 and delivers the paper 203 by the rotation towards the gripping roller 77d.

The roll-paper delivery roller 77h also rotates in a direction opposite to the delivery direction so that the paper 203 delivered towards the gripping roller 77d is rewound around the roll paper 202 of the roll-paper storage section 22.

(Sensors) As shown in FIGS. 2 and 5, the printer 100 includes, at a position that is closer to the printing upstream path 86 than the gripping roller 77d and is on the pathway of the printing path 82, a first sensor 96 that is configured to detect the passage of a front end 201a in the sending direction of the paper 201 when it is sent to the printing upstream path 86 by the gripping roller 77d.

Furthermore, the printer 100 includes a second sensor 97 at a position closer to the printing downstream path 87 than the gripping roller 77d and on the pathway of the printing path 82. The second sensor 97 is configured to detect the passage of the rear end in the sending direction of the paper 201 when it is sent to the printing upstream path 86 by the gripping roller 77d.

(Meandering Correction Mechanism) Next, the meandering correction mechanism 50 will be described as follows with reference to FIGS. 6 to 11. FIGS. 6, 7, and 8 show a condition before correcting the meandering of the paper 201. FIG. 6 is a perspective view, FIG. 7 is a plan view, and FIG. 8 is a schematic view of FIG. 7. FIGS. 9, 10, and 11 show a condition in which the meandering of the paper 201 is being corrected. FIG. 9 is a perspective view, corresponding to FIG. 6. FIG. 10 is a plan view, corresponding to FIG. 7. FIG. 11 is a schematic view, corresponding to FIG. 8.

The meandering correction mechanism 50 is configured to correct the meandering of the sheet paper 201, which is transported through the transport path 80, where the sheet paper 201 travels obliquely or changes the direction with respect to the transport direction. As shown in FIG. 6, the meandering correction mechanism 50 includes the feeding path 81 (one example of the transport path), the reversing roller 77c (one example of the drive roller), the gripping roller 77d (one example of the downstream roller), a pair of left and right guide members 51, a pair of left and right movable guide members 52, and a pair of left and right cam members 53.

Here, the reversing roller 77c is provided in an upstream region of the feeding path 81 in the sending direction of the sheet paper 201. The reversing roller 77c is configured to restrict the paper 201 by making contact with the sheet paper 201 and to be movable between a gripping position to send the sheet paper 201 and a retracted position to release the restriction of the sheet paper 201 by moving away from the paper 201.

The gripping roller 77d is provided in the printing path 82. Since the printing path 82 is provided downstream in the feeding path 81 in the sending direction of the sheet paper 201, the gripping roller 77d is provided downstream in the feeding path 81 in the sending direction of the sheet paper 201. Similar to the reversing roller 77c, the gripping roller 77d is configured to movable between a gripping position to restrict the sheet paper 201 by making contact with the sheet paper 201 that has passed through the feeding path 81 and a retracted position to release the restriction of the sheet paper 201 by moving away from the paper 201.

The spacing between the reversing roller 77c and the gripping roller 77d along the feeding path 81 is shorter than the length of the sheet paper 201. Therefore, when the front end 201a of the sheet paper 201, which has been sent in the sending direction along the feeding path 81 by the reversing roller 77c, reaches the gripping roller 77d, the rear end of the sheet paper 201 is at a position where it can make contact with the reversing roller 77c.

As shown in FIG. 7, the left and right guide members 51, as a pair arranged in the width direction W, are fixedly provided on both edges of the feeding path 81, respectively. The respective guide members 51 are positioned outside of both side edges of the sheet paper 201 passing through the feeding path 81 and include wall surfaces that vertically raised in the thickness direction of the sheet paper 201 from the surface of the feeding path 81. Accordingly, the guide members 51 guide the paper 201 by limiting the positions of both side edges of the sheet paper 201 as the side edges of the sheet paper 201 passing through the feeding path 81 make contact with the raised wall surfaces.

Each guide member 51 includes a first portion 51b, which is positioned upstream in the sending direction of the paper 201 shown by the arrow in FIG. 7, and a second portion 51a positioned downstream therein.

As shown in the schematic view of FIG. 8, the left and right first portions 51b as a pair are formed to have a spacing that narrows gradually in the sending direction (shown by the arrow) of the sheet paper 201, such that their upstream sections closest to the reversing rollers 77c have a spacing L2 (L2 is 207 [mm] as one example) wider than the width W1 of the paper 201 and that their downstream sections 51d closest to the second portions 51a have a spacing L1 substantially equal to the width W1 of the sheet paper 201, and extend from a first region a1 to a second region a2. In this example, the first portion 51b and the second portion 51a are formed into one piece. The pair of the first portions 51b in the present embodiment is formed so that the spacing therebetween is linearly and gradually narrowed. However, the first portions 51b are not limited to one that is formed linearly and gradually narrowed.

On the other hand, the second portions 51a are formed to be parallel with each other along the sending direction with the spacing L1 (L1 is 203 [mm] as one example) substantially equal to the width W1 of the sheet paper 201 and are connected with the downstream sections having the narrowest spacing of the first portions 51b.

When an area between the reversing rollers 77c (rotation center of the reversing rollers 77c) and the second portions 51a (center portion along the sending direction) is halved into the first region a1 upstream in the sending direction and the second region downstream therein, that is, when it is halved into the first region a1 close to the reversing rollers 77c and the second region a2 close to the second portions 51a, upstream sections 51c of the first portions 51b, which are closest to the reversing rollers 77c, are disposed to be positioned in the first region a1, and downstream sections 51d of the first portions 51b, which are closest to the second portions 51a, are disposed to be positioned in the second region a2.

Thus, the sections of the first portions 51b, which have the spacing L2 therebetween wider than the width W1 of the sheet paper 201 and which are closest to the reversing rollers 77c, are positioned in the first region a1, thereby almost certainly sending the sheet paper 201, which is sent by the reversing rollers 77c, into a space between the first portions 51b. Then, the sheet paper 201 is guided and transported by the first portions 51b to the second portions 51a, which have the spacing L1 substantially equal to the width W1 of the sheet paper 201.

In an example shown in FIG. 8, the downstream sections 51d in the first portions 51b, which are closest to the second portions 51a, extend to the second region a2.

As shown in FIG. 7, the left and right movable guide members 52 as a pair, which are arranged in the width direction W, are respectively provided on both side edges of the feeding path 81, upstream of the guide members 51 in the sending direction of the sheet paper 201 and downstream of the reversing rollers 77c therein. As shown in FIG. 7, the movable guide members 52 are also respectively provided on both sides of the feeding path 81.

The printer 100 may switch the positions in the transport direction of the pair of left and right movable guide members 52 and the reversing rollers 77c to dispose the reversing rollers 77 downstream of the movable guide members 52 and the movable guide members 52 upstream of the reversing rollers 77. Even if these positions are switched, it is possible to apply the same configuration and operation as those in the case of no switch.

The movable guide members 52 as a pair are formed to be parallel with each other along the sending direction. The movable guide members 52 as a pair are each provided on a single common shaft 52a to be slidable in the axial direction. The shaft 52a is fixed to the center of the pair of left and right cam members 53. Both ends of the shaft 52a are rotatably supported on left and right frame side plates 56.

The movable guide members 52 are formed to be positioned outside of both side edges of the paper 201 passing the feeding path 81 and to include wall surfaces vertically raised in the thickness direction of the sheet paper 201. The movable guide members 52 are provided to be movable in the width direction W along the shaft 52a between positions away from the side edges of the sheet paper 201 passing the feeding path 81 and positions in contact with both side edges of the sheet paper 201.

Specifically, the movable guide members 52 as a pair are provided to be movable between the spacing L2 wider than the width W1 of the sheet paper 201 and the spacing L1 substantially equal to the width W1 of the sheet paper 201. When they have the spacing L1 substantially equal to the width W1 of the sheet paper 201, they take the positions in contact with both side edges of the sheet paper 201.

The positions, where the movable guide members 52 as a pair are in contact with both side edges of the sheet paper 201, are set as positions where the respective movable guide members 52 are disposed on extension lines along the front-rear direction L of the downstream portions 51a of the guide members 51. The positions, when the movable guide members 52 as a pair have the spacing L2 wider than the width W1 of the sheet paper 201, are set as positions where the movable guide members 52 are disposed on extension lines along the front-rear direction L of the upstream end portions of the upstream portions 51b of the guide members 51.

The printer 100 may include an adjusting mechanism that limits and adjusts the positions of the movement of the movable guide members 52 as a pair to sides where they are brought into contact with both side edges of the sheet paper 201, within the movable range thereof. This adjusting mechanism includes, for example, a pair of abutting portions that abut inner surfaces of the movable guide members 52 as a pair and fixed portions each being fixed at any single position or any of multiple positions in the width direction W (direction orthogonal to the transport direction) of the sheet paper 201. It can be configured by a plate-shape limiting member (adjusting plate, etc.) that is disposed between the movable guide members 52 as a pair and a fixing means (fixing bolts, etc.) that fixes this limiting member. The fixed portion is, for example, an elongated hole that extends in the width direction W of the sheet paper 201, and a fixing bolt as a fixing means is inserted into this elongated hole.

Thereby, when the pair of movable guide members 52 moves to and abuts both side edges of the sheet paper 201, it is possible to adjust the position where the pair of movable guide members 52 moves to and stops on the sides of both side edges of the sheet paper 201, such that the sheet paper 201 is corrected to the normal posture at its no displacement position with respect to a downstream end portion in the sending direction in the second portions 51a of the guide members 51.

The limiting member is not limited to a single member. The limiting member may be separated into a limiting member for one of the pair of movable guide members 52 and another limiting member for the other of the pair of movable guide members 52.

Furthermore, when the movable guide members 52 as a pair have the spacing L2 therebetween wider than the width W1 of the sheet paper 201, they may be positioned to have a spacing wider than that between their positions on extension lines along the front-rear direction L of the upstream ends of the upstream portions 51b of the guide members 51.

Each of the cam members 53 as a pair, which is positioned outside in the width direction W of the movable guide members 52, is fixed to the shaft 52a. The cam members 53 are integrally rotatable with the shaft 52a about its axis. Each of the cam members 53 is integrally formed of a first cam 53a and a second cam 53b. The first cam 53a is formed on an outer peripheral surface of the cam member 53. A cam surface of the first cam 53a is in abutment with a follower member 55 that is integrally provided with the movable guide member 52. The rotation of the cam member 53 displaces the follower member 55, which is biased by a spring 57 inward in the width direction W, and outward in the width direction W, thereby moving the movable guide member 52 in the width direction W.

Therefore, the first cams 53a are exemplary moving members that move the movable guide members 52 in the width direction W between a position with the spacing L2, which is wider than the width W of the paper 201, and a position with the spacing L1, which is substantially equal to the width W of the sheet paper 201.

The second cam 53b is formed on an inner peripheral surface of the cam member 53. The second cam 53b is in abutment with a link plate 54 that supports a shaft 77c1 of the reversing rollers 77c. The link plate 54 is rotatably supported about a shaft 77c2 that is supported on left and right frame side plates 56. When the cam members 53 rotate about the shaft 52a, the second cams 53b displace the link plates 54 outward in the radial direction of the cam members 53. With this, the link plates 54 rotate about the shaft 77c2, thereby retracting the reversing rollers 77c, which are supported on the shaft 77c1, from their position in abutment with the sheet paper 201 to the retracted position.

Therefore, the second cam members 53b are exemplary retracting members that retract the reversing rollers 77c at the gripping position in contact with the paper 201 to the retracted position away from the sheet paper 201, in a condition in which the front end 201a in the sending direction of the paper 201 has reached the downstream portions 51a of the guide members 51.

Thus, the cam members 53 interlock the movable guide members 52 and the reversing rollers 77c. Specifically, when the cam members 53 are in a first rotational position, the reversing rollers 77c are in a position in contact with the sheet paper 201, and the movable guide members 52 are in a position with the spacing L2 away from both side edges of the paper 201. On the other hand, when they are in a second rotational position by the rotation of the cam members, the reversing rollers 77c are in the retracted position not in contact with the sheet paper 201, and the movable guide members 52 take a position with the spacing L1 in contact with both side edges of the sheet paper 201.

Immediately after the cam members 53 start to rotate from the first rotational position toward the second rotational position, the reversing rollers 77c turn into a condition away from the sheet paper 201. Therefore, before the cam members 53 reach the second rotational position, the reversing rollers 77c turn into a condition where they have reached the retracted position.

In contrast, even if the cam members 53 have started to rotate from the first rotational position toward the second rotational position to make the reversing rollers 77c reach the retracted position, the movable guide members 52 only slightly narrow from the spacing L2. Only when the cam members 53 have reached the second rotational position, they turn to have the spacing L1 and take the position in contact with both side edges of the sheet paper 201.

In other words, when the cam members 53 rotate from the first rotational position toward the second rotational position, the reversing rollers 77c firstly move away from the paper 201 to release the restriction on the side of the rear end 201b of the sheet paper 201. As the rotation proceeds further, the movable guide members 52 are brought into contact with both side edges of the sheet paper 201.

The cam members 53 are rotated between the first rotational position and the second rotational position by the control by the controller 95 of the printer 100.

(Reversing Roller Retraction Control upon Printing) As described in the following, the controller 95 controls the movement (retraction) of the reversing rollers 77c to the retracted position.

As mentioned hereinafter, in the printing step on the sheet paper 201 by the printing section 30 of the printer 100, the sheet paper 201 is once sent to the printing upstream path 86 through the printing path 82 by the control of the controller 95. Upon this, the sheet paper 201 passes through the printing path 82, but the controller 95 does not print on the sheet paper 201. Then, the controller 95 reverses the sending direction by rotating the gripping roller 77d to pass the sheet paper 201 through the printing path 82, and during this passing the controller 95 controls the printing section 30 to conduct printing on the sheet paper 201.

In this printing step, a part of the sheet paper 201 subjected to the printing on the printing path 82, that is, a part on the front-end side in the sending direction of the sheet paper 201 is sent from the printing path 82 to the printing downstream path 87.

Here, the length along the printing downstream path 87 between the gripping roller 77d, which sends the sheet paper 201 on the printing path 82, and the reversing roller 77c, which is provided on the feeding path 81 joined by the printing downstream path 87, is set to be shorter than the length in the sending direction of the sheet paper 201. The spacings between the other transport rollers 77a to 77h are similar.

Thus, the transport means 70 to send the sheet paper 201 is configured that the pitch between the two adjacent transport means 70 along the transport path 80 is shorter than the length of the sheet paper 201 to be delivered, in order to deliver the sheet paper 201 to be sent along the transport path 80 by each transport roller 77a to 77h constituting the transport means 70.

Therefore, when the side of the front end 201a in the sending direction of the sheet paper 201, which is being sent to the printing downstream path 87 by the gripping roller 77d, reaches the reversing roller 77c, it can happen that a region on the side of the rear end 201b of the sheet paper 201 is still passing the printing section 30.

In this way, when the front end 201a of the sheet paper 201 in the printing step has been brought into contact with the reversing roller 77c, if there is even a slight difference between the rotational speed of the gripping roller 77d and that of the reversing roller 77c, the sending speed of the sheet paper 201 changes momentarily. In this case, a subtle displacement of the printing (uneven printing) may occur on a part of the sheet paper 201 during the printing by the printing section.

Thus, the printer 100 moves the reversing roller 77c, with which the front end 201a of the sheet paper 201 during the printing by the printing section 30 is brought into contact, while it is sent by the gripping roller 77d, to the retracted position, which is not in contact with the sheet paper 201, by the control of the controller 95.

In other words, the printer (printer 100 in the embodiment) includes a printing section (printing section 30) that conducts printing on a paper (sheet paper 201), a first drive roller (gripping roller 77d) that makes the paper pass through the printing section, and a second drive roller (reversing roller 77c) that is provided downstream of the printing section and the first drive roller in the sending direction of the paper, and is configured that the second drive roller is movable to a retracted position that does not make contact with the paper during the printing by the printing section.

Thus, the printer 100 can prevent the occurrence of uneven printing on the sheet paper 201, due to no contact of the reversing roller 77c with the sheet paper 201 during the printing.

Furthermore, the printer includes a feeding path (feeding path 81) that sends the paper to the printing section in a manner to reverse the front and back surfaces of the paper, downstream in the sending direction of the transport path (printing downstream path 87) where the paper printed in the printing section passes through. The second drive roller is a reversing roller (reversing roller 77c) that sends to the feeding pathway the printed paper sent through the feeding path.

In the printer, the second drive roller is a drive roller (feeding roller 77b) that is provided in the vicinity of a feeding roller, which sends the paper delivered from the paper tray (sheet-paper storage section 21), and that sends the paper, which has been sent by the feeding roller, to the feeding path, and the feeding roller and the second drive roller are driven by a single motor.

In the printer 100 which drives the feeding roller 77b and the reversing roller 77c by a single motor, the rotational direction of the feeding roller 77b and that of the reversing roller 77c always result in the rotation in the same direction.

Here, for example, when two sheets of the paper 201 are sent from the sheet-paper storage section 21 to the feeding path 81 in an overlapped state (overlapped sending), it is possible to pull back only one of the overlapped two sheets of the paper 201 to the sheet-paper storage section 21 by controlling the rotational direction of the feeding roller 77b to result in the opposite direction.

However, when the reversing roller 77c also rotates together with the feeding roller 77b, the overlapped two sheets of the paper 201 are both pulled back to the sheet-paper storage section 21 to result in no resolution of the overlapped state.

Here, a printer configured by respectively driving the feeding roller 77b and the reversing roller 77c by separate motors can rotate only the feeding roller 77b in the opposite direction, but a printer configured by driving the feeding roller 77b and the reversing roller 77c by a single motor cannot rotate only the feeding roller in the opposite direction.

The printer 100, however, can move the reversing roller 77c to the retracted position not in contact with the sheet paper 201. Therefore, even if it is configured by driving the feeding roller 77b and the reversing roller 77c by a single motor, only the rotation of the feeding roller 77b can be transmitted to the sheet paper 201, with no transmission of the rotation of the reversing roller 77c to the paper 201, by rotating the feeding roller 77b and the reversing roller 77c in the opposite directions in a condition in which the reversing roller 77c has been moved to the retracted position.

Therefore, even though the printer 100 is configured by driving the feeding roller 77b and the reversing roller 77c by a single motor, it is possible to pull back only one of the overlapped two sheets of the sheet paper 201 to the sheet-paper storage section 21 to resolve the overlapped state by rotating the feeding roller 77b in the opposite direction in a condition in which the reversing roller 77c has been moved to the retracted position.

(Paper Guide Opening/Closing Mechanism) An opening/closing mechanism of a paper guide 90 that covers the transport path 80 will be described as follows with reference to FIGS. 12 to 16. FIG. 12 is a perspective view of a major part, showing a condition in which the paper guide 90 is closed. FIG. 13 is a perspective view of the major part, showing a condition in which the paper guide 90 is opened.

FIG. 14 is a sectional view of a major part, showing a condition in which the paper guide 90 is closed and the reversing roller 77c is in contact with the sheet paper 201. FIG. 15 is a sectional view of the major part, showing a condition in which the paper guide 90 is closed and the reversing roller 77c is away from the sheet paper 201. FIG. 16 is a sectional view of the major part, showing a condition in which the paper guide 90 is opened.

The paper guide 90 is a partition plate that covers the transport path 80 by partitioning the transport path 80 in the thickness direction of the sheet paper 201, and is disposed in a manner to partition the outer peripheral side of a reversing section that is a curved region including the reversing roller 77c mounted from the printing downstream path 87 to the feeding path 81 in the printer 100 of the present embodiment, as shown in FIGS. 1 and 3.

The paper guide 90 is configured to open and close freely in a manner to be switched between a closed state, as shown in FIG. 12, in which the transport path 80 (the reversing section as a curved region including the reversing roller 77c mounted from the printing downstream path 87 to the feeding path 81) is covered, and an open state, as shown in FIG. 13, in which this reversing section is exposed. The user manually conducts opening and closing of the paper guide 90.

The paper guide 90 includes a cover plate 91 and side plates 92 that are respectively formed on both side portions of the cover plate 91 to be integral with the cover plate 91. The cover plate 91 is formed like a part of the circumference of a cylinder and covers the reversing section from the outer peripheral side, as shown in FIGS. 14 and 15. Each side plate 92 is formed to rise toward the outside of the circumference of the cylinder with respect to the cover plate 91.

Each side plate 92 is supported on the shaft 77c2, which is the rotational center of the link plates 54. With this, the paper guide 90 becomes rotatable about the shaft 77c2 similar to the link plates 54, and is switched by this rotation between the above-mentioned closed state (FIGS. 12, 14 and 15) and open state (FIGS. 13 and 16).

Furthermore, each side plate 92 is rotatably supported about the shaft 77c2, similar to the link plate 54. Each side plate 92 is formed with an elongated hole 92a that allows the shaft 77c1 supporting thereon the reversing rollers 77c to pass therethrough. As shown in FIGS. 14 to 16, the shaft 77c1 is disposed on the outer side of the cover plate 91 and is passed through the elongated hole 92a formed in each side plate 92.

The elongated hole 92a is formed to extend along a range where the shaft 77c1 moves by a relative rotation of the link plate 54 about the shaft 77c2, in order to allow the link plate 54 to relatively rotate about the shaft 77c2 with respect to each side plate 92.

Here, the range that allows a relative rotation of the link plate 54 with respect to each side plate 92 is set to correspond to the range where the shaft 77c1 moves (arc shape centered on the shaft 77c2), when the reversing roller 77c moves between the position in contact with the sheet paper 201 (FIG. 14) and the retracted position away from the sheet paper 201 (FIG. 15) in the closed state of the paper guide 90 (FIG. 12).

In other words, the reversing roller 77c can move between the position in contact with the sheet paper 201 and the retracted position, while the paper guide 90 remains closed.

The cover plate 91 is formed with two openings 91a along the shaft 77c2. The opening 91a is an opening that makes the reversing roller 77c pass therethrough, to expose the reversing roller 77c, which is supported on the shaft 77c1 disposed on the outer side of the cover plate 91, to the transport path 80 (feeding path 81) on the inner side of the cover plate 91.

In the retracted position of the reversing rollers 77c, the reversing rollers 77c do not project from the inner surface of the cover plate 91 to the side of the transport path 80. Therefore, the retraction control of the reversing rollers 77c in the printing prevents the front edge of the sheet paper 201 during the printing from being caught by the reversing rollers 77c, thereby smoothly sending it along the inner surface of the cover plate 91.

The reversing rollers 77c are not configured by a long single object along the shaft 77c1, but are arranged as two objects distributed in the axial direction. The openings 91a formed in the cover plate 91 are not a single long opening in the axial direction, but are formed as two separate openings corresponding to the reversing rollers 77c.

<Operation> The above-configured printer 100 prints on the sheet paper 201, as follows. The following printing operation on the sheet paper 201 is an exemplary operation of the printer 100.

Firstly, the printer 100 delivers a single sheet of the sheet paper 201 at the top layer of a stack of the sheet paper 201 stored in the sheet-paper storage section 21 by rotating the sheet-paper delivery roller 77a (see FIG. 2) and transports that in the feeding path 81 by the rotation of the feeding roller 77b and the rotation of the subsequent reversing roller 77c.

Upon this, the cam member 53 is at the first rotational position. Therefore, the reversing rollers 77c are at the position to restrict the sheet paper 201 by making contact with the sheet paper 201, and the movable guide members 52 are at the position away from both side edges of the sheet paper 201 with the spacing L2.

The sheet paper 201, which has been sent through the feeding path 81, may turn into an oblique posture condition that is inclined relative to the sending direction or a meandering condition through the travelling direction change caused by the uneven frictional force when making contact with the reversing rollers 77c. Even in such condition, the front end 201a of the sheet paper 201 is sent within the range of the first portions 51b formed with the spacing L2 wider than the width W1 of the sheet paper 201.

Since the width between the first portions 51b becomes narrower as it proceeds in the sending direction, when the sheet paper 201 proceeds obliquely or meanders, either of the left and right side edges of the sheet paper 201 starts making contact with the first portion 51b, before the front end 201a of the sheet paper 201 reaches portions connected with the second portions 51a with the narrowest width therebetween.

A portion on the side of the front end 201a of the sheet paper 201, which has been brought into contact with the first portion 51b, is sent along the inclination of the first portion 51b (inclination relative to the sending direction, formed to make the spacing narrow gradually toward the second portion 51a). In other words, the front end 201a of the sheet paper 201, which has been sent with an obliquely inclined posture, should proceed straight along the sending direction with such posture that is still obliquely inclined, but the direction, in which a portion on the side of the front end 201a moves, deviates from the sending direction of the side of the rear end 201b of the sheet paper 201 due to correcting the sending direction to be along the first portion 51b.

In other words, the moving direction of a portion on the side of the front end 201a in a single sheet of the paper 201 is limited by the first portion 51b, and a portion on the side of the rear end 201b moves in the sending direction in a still inclined manner under a restriction by the reversing rollers 77c. As a result, the moving direction of a portion on the side of the front end 201a of the sheet paper 201 becomes different from that of a portion on the side of the rear end 201b. Therefore, an intermediate portion between the portion on the side of the front end 201a and that of the rear end 201b is subject to stress that is uneven in the width direction W.

This uneven stress makes it impossible to maintain flatness of a single sheet of the paper 201. Thus, the sheet paper 201 is bent in the thickness direction to release the uneven stress, so that one side in the width direction W (side where the direction of the front end 201a relative to that of the rear end 201b becomes inside in the width direction) turns into a mountain-like raised state in the thickness direction.

When the sheet paper is sent further and the front end 201a reaches the second portions 51a, which are parallel with each other along the sending direction with the spacing L1 equal to the width W1 of the sheet paper 201, both side edges of the front end 201a make contact with the second portions 51a, respectively. With this, as shown in FIG. 8, a part on the side of the front end 201a of the sheet paper 201 is corrected to have the original normal posture with both side edges that are parallel with each other along the sending direction.

In contrast, a part on the side of the rear end 201b of the sheet paper 201 is restrained by the reversing rollers 77c and thereby maintained in an oblique condition. With this, an intermediate portion between the portion on the side of the front end 201a and that of the rear end 201b forms a bent portion K in a mountain-like raised state in the thickness direction.

The mountain-like raised state of the sheet paper 201 refers to a state in which the sheet paper 201 has been deformed into a protrusion shape even slightly in the thickness direction from a flat state extending straight in the sending direction.

The mountain-like refers to one deformed into a protrusion shape in the thickness direction of the sheet paper 201, regardless of whether it is perceived as a mountain-like shape or not and regardless of the height (deformation amount) of the bent portion K or the extent of the bent range.

Here, the feeding path 81 includes a space S that accommodates the bent portion K of the sheet paper 201 in the mountain-like raised state in the thickness direction and that extends in the thickness direction of the sheet paper 201. If there were no such space S, the sheet paper 201 would not be formed with the bent portion K in the feeding path 81 during its transport, but plastic deformation would occur in another part of the sheet paper 201. For example, when the sheet paper 201 sent with an obliquely inclined posture is guided by the guide members 51, a front end corner portion in the sending direction of the sheet paper 201 is sent out by the reversing rollers 77c in a condition in contact with an inner wall constituting the guide member 51.

This would cause deformation in the sheet paper 201, such as bending near the front end corner portion in the sending direction with a crease(s) along this inner wall. In such condition, the sheet paper 201 tends to jam in the feeding path 81. Even if printing is possible with no jamming, it becomes a creased condition.

The space S possessed by the feeding path 81 corresponds to “a space extending in a thickness direction of the sheet paper” in the present disclosure, even if the bent portion K of the sheet paper 201 is within the height of the guide member 51 (below the height of the wall surface of the guide member 51).

Before the front end 201a of the sheet paper 201 reaches the gripping rollers 77d (downstream rollers), which are provided downstream in the sending direction, during sending the sheet paper 201, the gripping rollers 77d move to a retracted position by the control of the controller 95 to turn into a condition not in contact with the sheet paper 201.

In a condition in which the gripping rollers 77d have moved to the retracted position, the reversing rollers 77c further send the sheet paper 201 by the control of the controller 95. When the front end 201a of the sheet paper 201 has reached the position to make contact with the gripping rollers 77d which had returned to the gripping position, the reversing rollers 77c stop sending the sheet paper 201.

From this condition, the cam members 53 begin to rotate from the first rotational position toward the second rotational position by the control of the controller 95. As soon as the cam members 53 begin to rotate to move from the first rotational position, the reversing rollers 77c turn into a condition in which they are away from the sheet paper 201 and have moved to the retracted position. As a result, a portion on the side of the rear end 201b of the sheet paper 201 is released from the restraint by the reversing rollers 77c and turns into a free condition in which it is freely movable.

With this, as shown in FIG. 11, a portion on the side of the rear end 201b of the sheet paper 201, which has turned into a free state, is corrected to the normal posture in which both side edges are parallel with the sending direction, to follow the posture of a portion on the side of the front end 201a, with respect to the portion on the side of the front end 201a corrected to the normal posture by the limitation of the second portions 51a, by the restoring force of the bent portion K (force by which the bent portion K tries to restore a flat state) in a mountain-like raised state in the intermediate portion.

Thus, the printer 100 of the present embodiment can correct the overall posture of a single sheet of the paper 201 to the normal posture, in which both side edges are parallel with the sending direction, by only the action of the guide members 51 and the movement of the reversing rollers 77c to the retracted position.

In the printer 100, the cam members 53 rotate further toward the second rotational position by the control of the controller 95. With this, the left and right movable guide members 52 as a pair are displaced to narrow the spacing therebetween. When the cam members 53 reach the second rotational position, the movable guide members 52 are brought into contact with both side edges of the sheet paper 201 and can further securely correct the posture of the sheet paper 201 to the normal posture (posture with both side edges parallel along the sending direction).

In other words, in the printer 100, as described above, when the front end 201a of the sheet paper 201 reaches a position to make contact when the gripping rollers 77d have returned to the gripping position, the cam members 53 at the first rotational position (FIGS. 6 and 7) are rotated until the second rotational position (FIGS. 9 and 10) by the control of the controller 95.

As the cam members 53 start their rotation toward the second rotational position, as shown in FIGS. 9 and 10, the second cams 53b press the link plates 54 outward in the radial direction of the cam members 53, thereby rotating the link plates 54 about the shaft 77c2 and rotating the shaft 77c1 forward which is supported on the link plates 54. With this, the reversing rollers 77c provided on the shaft 77c1 move to the retracted position away from the sheet paper 201 sandwiched between the reversing rollers 77c and reversing follower rollers 77c3.

When the cam members 53 are rotated further to reach the second rotational position, the cam surfaces of the first cams 53a are displaced inward in the width direction W, thereby displacing the follower members 55 inward in the width direction W which are in contact with the cam surfaces of the first cams 53a and are biased inward in the width direction W by the springs. With this, the movable guide members 52, which are integral with the follower members 55, are also displaced inward in the width direction W, resulting in the narrowed spacing L1 between the movable guide members 52 as a pair.

With this, the movable guide members 52 as a pair respectively push side edges on the side of rear end 201b of the sheet paper 201, inward in the width direction W, which are in a condition not restrained by the gripping rollers 77d and the reversing rollers 77c.

Here, the spacing L2 between the movable guide members 52 as a pair is substantially equal to the width W1 of the sheet paper 201, and each movable guide member 52 is disposed on an extension line in the front-rear direction L of the downstream portion 51a of the guide member 51.

Therefore, even if the sheet paper 201 is in a condition in which the correction to the normal posture by the above-mentioned action of the guide members 51 and retraction movement of the reversing rollers 77c is not complete, the movable guide members 52 push a portion on the side of the rear end 201b of the sheet paper 201 inward in the width direction W to respectively bring both side edges on the side of the rear end 201b of the sheet paper 201 into contact with the movable guide members 52, thereby correcting the positions of both side edges.

Thus, even when only the guide members 51 could not correct the sheet paper 201 to the normal posture, the printer 100 of the present embodiment can surely correct the sheet paper 201 to the normal posture by the movable guide members 52.

After the sheet paper 201 is corrected to the normal posture, the controller 95 returns the gripping rollers 77d from the retracted position to the gripping position in contact with the sheet paper 201. With this, the sheet paper 201 is restrained by the gripping rollers 77d in a condition in which its overall posture has been corrected to the normal posture.

As the gripping rollers 77d rotate by the control of the controller 95, the sheet paper 201 is sent from the feeding path 81 to the printing path 82, while maintaining the normal posture.

After the sheet paper 201 is sent to the printing path 82, the cam members 53 are returned from the second rotational position to the first rotational position by the control of the controller 95, thereby returning the spacing between the movable guide members 52 to the wide spacing L2 and returning the reversing rollers 77c to the position where the sheet paper 201 can be gripped.

The sheet paper 201, which has passed through the printing path 82, is guided to the printing upstream path 86 by switching the printing-discharge switching flap 72.

When the front end of the sheet paper 201 travels to the end of the printing upstream path 86, the gripping rollers 77d reverse (their rotational direction becomes opposite) so that the sheet paper 201 travels to the printing downstream path 87, while passing through the printing path 82 and being printed on the front surface of the sheet paper 201.

As the sheet paper 201 with the printed front surface travels from the printing path 82 to the printing downstream path 87, the front end thereof travels to the feeding path 81 and makes contact with the reversing rollers 77c, followed by being transported again through the feeding path 81 by the rotation of the reversing rollers 77c.

The sheet paper 201 sent from the printing downstream path 87 to the feeding path 81 turns into a condition in which its front and back surfaces have been reversed. When the reversed sheet paper 201 is transported through the feeding path 81, meandering of the sheet paper 201 is corrected again by the meandering correction mechanism 50, thereby correcting the sheet paper 201 to the normal posture.

Thus, the sheet paper 201 with the corrected posture is guided from the printing path 82 to the printing upstream path 86.

In the printer 100, in addition to the feeding path 81, which is also a path for reversing the front and back surfaces of the sheet paper 201 with the printed front surface, the printing downstream path 87, through which the sheet paper 201 with the printed front surface passes, also may include the above-mentioned meandering correction mechanism. In this case, the printing downstream path 87 corresponds to the transport path, the gripping rollers 77d correspond to the drive rollers, and the reversing rollers 77c correspond to the downstream rollers. Therefore, a pair of left and right guide members 51 is provided at a portion close to the reversing rollers 77c in the printing downstream path 87. The printer 100 may include the guide members 51 in the printing upstream path 86 and/or the discharge path 83, too.

While the sheet paper 201 subjected to the meandering correction is returned from the printing upstream path 86 to the printing path 82, the back surface of the sheet paper 201 is printed in the printing section 30, and at the same time it travels to the printing downstream path 87.

The sheet paper 201, which has completed the printing on the back surface by traveling from the printing path 82 to the printing downstream path 87, passes through the printing path 82 by reversing the rotational direction of the gripping rollers 77d and then is transported to the discharge path 83 by switching the printing-discharge switching flap 72. The sheet paper 201 sent to the discharge path 83 is passed from the gripping roller 77d to the sending roller 77e.

In the discharge path 83, the sheet paper 201 travels forward through the cutter section 40 by the rotation of the sending roller 77e. The cutter section 40 cuts an unnecessary part at the rear end in the sending direction of the sheet paper 201. The cut-off unnecessary part falls into the trash box 16 (see FIG. 2) and is stored inside the trash box 16.

The sheet paper 201, of which rear-end unnecessary part has been cut off, travels forward by the rotation of the sending roller 77e and is passed to the first discharge roller 77f. The sheet paper 201 is transported by the rotation of the first discharge roller 77f. In a condition that the discharge-path switching member 71 has been switched to the lower side at the separation point, the sheet paper 201 is guided to the upper discharge path 85 and is discharged from the upper outlet 13b into the stacker 12a by the rotation of the second discharge roller 77g which is disposed close to the upper outlet 13b.

On the other hand, in a condition that the discharge-path switching member 71 has been switched to the upper side at the separation point, the sheet paper 201 is guided to the front discharge path 84 and is discharged from the front outlet 13a to the outside.

(Control of Positioning of Printing on Front and Back Surfaces) Here, when the controller 95 conducts the above-mentioned printing on the front and back surfaces of the sheet paper 201, the control to send the sheet paper 201 by driving the gripping rollers 77d will be described as follows.

As mentioned above, the printer 100 conducts printing by the printing section 30, while sending the sheet paper 201 from the printing path 82 to the printing downstream path 87, not only when printing on the front surface, but also when printing on the back surface.

Here, when the front and back surfaces of the sheet paper 201 are reversed, the ends in the length direction of the sheet paper 201 are also reversed. In other words, when one end in the length direction of the sheet paper 201 is defined as, for example, an end A and the other end is defined as, for example, an end B, and when printing on the front surface of the sheet paper 201, the sheet paper 201 is sent with the end A as the front end. When the sheet paper 201 is reversed between the front and back surfaces thereof, the front end in the sending direction of the sheet paper 201 is reversed between the end A and the end B. Therefore, when printing on the back surface of the sheet paper 201, the sheet paper 201 is sent with the end B as the front end.

Therefore, in printings on the front and back surfaces of the sheet paper 201, when both printings are conducted with respect to the front end in the sending direction of the sheet paper 201 or when both printings are conducted with respect to the rear end in the sending direction of the sheet paper 201, the printing on the front surface of the sheet paper 201 is conducted at a position with respect to, for example, the end A, and the printing on the back surface of the sheet paper 201 is conducted at a position with respect to, for example, the end B.

When the length of the printing content (image, etc.) is much shorter than that of the sheet paper 201 (the length between the ends A and B), the printing content approaches the end A on the front surface of the sheet paper 201, and it approaches the end B on the back surface thereof. In other words, the printing contents approach different ends on the front and back surfaces of the sheet paper 201. Even if one tries to cut off a marginal area with no printing content thereon, such cutting off is impossible, because the marginal areas do not match with each other between the front and back surfaces of the sheet paper 201.

To solve such task, the printer 100 of the present embodiment controls the sending of the sheet paper 201 by fixing the reference position in sending the sheet paper at a constant position of the sheet paper 201 itself, regardless of whether printing is conducted on the front surface or back surface of the sheet paper 201.

In other words, in the printer 100, the controller 95 controls the sending by fixing the reference in sending the sheet paper 201 at a constant position of the sheet paper 201 itself such that the printing contents on both front and back surfaces of the sheet paper 201 approach either of the ends A and B.

Specifically, as shown in FIG. 2, the printer 100 includes the first sensor 96 and the second sensor 97. Each of the first sensor 96 and the second sensor 97 is an optical sensor that detects the passage of the sheet paper, for example, by the change in light intensity due to the passage of the sheet paper 201.

The first sensor 96 is provided at a position on the downstream side of the printing section 30 (the side close to the printing upstream path 86) in the printing path 82. The first sensor 96 detects the front end of the sheet paper 201 in the sending direction, when the sheet paper 201 is sent from the printing path 82 to the printing upstream path 86.

The second sensor 97 is provided on the upstream side in the printing path 82 (the side close to the feeding path 81) and at a position on the upstream side of the gripping rollers 77d. The second sensor 97 detects the front end of the sheet paper 201 in the sending direction, when the sheet paper 201 is sent from the printing path 82 to the printing downstream path 87.

When printing is conducted on the front surface of the sheet paper 201, the controller 95 sets the printing start position based on the detection result by the first sensor 96. When printing is conducted on the back surface of the sheet paper 201, it sets that based on the detection result by the second sensor 97.

Here, when printing is conducted on the front surface of the sheet paper 201, the controller 95 firstly sends the sheet paper 201 by the gripping rollers 77d from the printing path 82 to the printing upstream path 86. Upon this, the first sensor 96 detects the front end (e.g., end A) in the sending direction of the sheet paper 201.

The controller 95 sends the sheet paper 201 to the printing upstream path 86 by the gripping rollers 77d by a predetermined first length (e.g., length M1), using the time when the first sensor 96 detects the end A of the sheet paper as the sending reference.

For example, when a step motor is used for rotating the gripping rollers 77d, the predetermined first length is set as a predetermined first number of steps by which the controller 95 drives the step motor. The first length is set as a length longer than the length (e.g., length M0) of the printing content on the front surface (M1>M0).

Then, while the controller 95 controls the rotational direction of the gripping rollers 77d to the opposite direction to send the sheet paper 201 from the printing path 82 to the printing downstream path 87, the controller 95 controls the printing section 30 to start printing on the front surface of the sheet paper 201. Upon this, the front end in the sending direction of the sheet paper 201 is the end B, but printing on the front surface of the sheet paper 201 is conducted by using the end A of the sheet paper 201 as the reference.

In other words, it starts printing of the printing content from a position that is away from the end A by the predetermined first length, toward the end A on the front surface of the sheet paper 201, to print by the length of the printing content. Therefore, the sheet paper 201 will have a margin ranging from the end A to a position having a length (=M1−M0) obtained by subtracting the length of the printing content from the first length.

After printing on the front surface, the sheet paper 201 with the end B as the front end in the sending direction is sent from the printing downstream path 87 to the feeding path 81 by the reversing rollers 77c, thereby reversing the front and back surfaces thereof. The sheet paper 201 with the end B as the front end in the sending direction, which has been sent to the feeding path 81 and reversed, is guided to the printing path 82 and is further sent to the printing upstream path 86.

When the end A as the rear end in the sending direction of the sheet paper 201 has passed the second sensor 97, the second sensor 97 detects the rear end (end A) of the sheet paper 201. The controller 95 sends the sheet paper 201 to the printing upstream path 86 by the gripping rollers 77d by a predetermined second length (e.g., length M2), using the time when the second sensor 97 detects the end A of the sheet paper 201 as the sending reference.

For example, when a step motor is used for rotating the gripping rollers 77d, the predetermined second length is set as a predetermined second number of steps by which the controller 95 drives the step motor.

The second length is set as a length obtained by subtracting the length of the printing content from the first length when printing on the front surface (M2=M1−M0).

Then, while the controller 95 controls the rotational direction of the gripping rollers 77d in the opposite direction to send the sheet paper 201 from the printing path 82 to the printing downstream path 87, the controller 95 controls the printing section 30 to start printing on the back surface of the sheet paper 201. Upon this, the front end in the sending direction of the sheet paper 201 is the end A, but printing on the back surface of the sheet paper 201 is conducted by using the end A of the sheet paper 201 as the reference.

In other words, the back surface of the sheet paper 201 will have a margin from the end A to the position of the second length (M2). It starts printing of the printing content from the second position toward the end B, to print by the length of the printing content from the position of the second length from the end A This allows the printer 100, on both of the front and back surfaces of the sheet paper 201, to make a margin as a range of the second length (M2) from one end (end A) of the sheet paper 201 itself and to print the printing content following the margin, in a range until the position of the length of the printing content (M0).

Therefore, it is possible on both of the front and back surfaces of the sheet paper 201 to make a common marginal region as a range from the position of the length (M2+M0) from the end A to the end B. Even if this marginal region is cut off, the printing contents on the front and back surfaces are not affected.

Thus, the printer 100 includes the gripping rollers 77d as a transport means to send the sheet paper 201, the printing section 30 to print on the sheet paper 201 while the sheet paper 201 is sent in one direction by the gripping rollers 77d, and the controller 95 to control the sending of the sheet paper 201 by setting the reference position in sending the sheet paper 201 at a specific position of the sheet paper 201 itself, irrespective of the front or back surface of the sheet paper 201, when the printing section 30 conducts printing on the front surface of the sheet paper 201 and when it conducts printing on the back surface of the sheet paper 201.

The printer 100 sets one end in the sending direction of the sheet paper 201 as the reference position for the sending.

Furthermore, the printer 100 includes the first sensor 96 and the second sensor 97, which detect one end of the sheet paper 201, respectively upstream and downstream of the gripping rollers 77d as a transport means in the sending direction of the sheet paper 201. The controller 95 sets the reference position in the sending at a specific position by a switching use of the detection result by the upstream first sensor 96 and that by the downstream second sensor 97 when printing on the front and back surfaces of the sheet paper 201.

As described above, the printer 100 of the present embodiment can correct meandering of the sheet paper 201 by the meandering correction mechanism 50 to correct the posture and orientation of the sheet paper 201.

In the printer 100 of the present embodiment, the pair of left and right cam members 53 is fixed to the shaft 52a. Therefore, it is possible to rotate the left and right cam members 53 in an interlocking manner by the rotation of the shaft 52a. This can displace the pair of left and right movable guide members 52 in an interlocking manner in the width direction W, too.

Therefore, the printer 100 of the present embodiment can be configured by only one motor to rotate the shaft 52a, such that meandering of the sheet paper 201 can be corrected by a simple structure with fewer parts, as compared with one in which each movable guide member 52 is provided with a motor to move the same.

In the printer 100 of the present embodiment, the second cams 53b as retracting members that retract the reversing rollers 77c to the position not in contact with the sheet paper 201, and the first cams 53a that move the movable guide members 52 within a movable range are integrally formed. Therefore, it is possible to interlock the movement (retraction to the retracted position) of the reversing rollers 77c and the movement (movement to the positions respectively in contact with both side edges of the sheet paper 201) of the movable guide members 52.

The printer 100 of the present embodiment was described as performing only once the retraction of the reversing rollers 77c from the sheet paper 201 and the pressing of the movable guide members 52 inward in the width direction W against both side edges of the sheet paper 201. However, it is optional to press multiple times both side edges of the sheet paper 201 inward in the width direction W by repeating multiple times the forward rotation and the reverse rotation of the cam members 53 between the first rotational position and the second rotational position.

By rotating the cam members 53 from the first rotational position to the second rotational position within a short period of time, the movable guide members 52 can impact on both side edges of the sheet paper 201 in a manner to tap them inward in the width direction W, thereby increasing the effect of correcting meandering of the sheet paper 201.

The printer 100 of the present embodiment can move the reversing rollers 77c to the retracted position during printing (FIG. 15), while the paper guide 90 remains closed (FIG. 12) without opening the same (FIGS. 13 and 16).

Furthermore, when jam of the sheet paper 201 occurs in the reversing section, the printer 100 can also turn the reversing rollers 77c together with the paper guide 90 into a condition away from the reversing section by opening the paper guide (FIGS. 13 and 15).

Therefore, when the paper guide 90 is opened, as compared with a printer configured by the reversing rollers 77c remaining in the reversing path, the printer 100 can improve accessibility to the reversing section, thereby facilitating removal of the sheet paper 201 jammed in the reversing section.

The two openings 91a, which are formed through the cover plate 91 and allow the reversing rollers 77c to pass therethrough, are distributed along the axial direction. This configuration is such that a plate surface of the cover plate 91, which is not an opening, is left between the two openings 91a. In contrast, in a configuration formed by a single opening that is long in the axial direction, the edge of the opening is elongated in the axial direction, resulting in a condition in which the plate surface of the cover plate 91 is not left behind.

Thus, in the configuration that the openings 91a allowing the reversing rollers 77c to pass therethrough are made into a single opening that is long in the axial direction, there is no portion within the single opening 91a that supports the sheet paper 201 over a long width range of the opening 91a. For example, when the sheet paper 201 is distorted to make an easy deformation toward the side of the opening 91a, the front end 201a of the sheet paper 201 tends to be projectingly deformed so as to enter the opening 91a.

Therefore, as compared with a configuration formed by a single opening that is long in the axial direction, in a configuration in which the plate surface of the cover plate 91 is left behind, the printer 100 allows the portion of the plate surface left behind between the two narrow-width openings 91a to support the sheet paper 201. Therefore, even if the sheet paper 201 is distorted to make an easy deformation toward the side of the openings 91a, it is hardly deformed to the extent that it enters the narrow-width openings 91a. Therefore, in the configuration in which the plate surface of the cover plate 91 is left behind, when the front end 201a of the sheet paper 201 in printing passes through the reversing section in a condition that the reversing rollers 77c have moved to the retracted position, it is possible to lower the risk of the front end 201a of the sheet paper 201 getting caught by the edges of the openings.

The printer 100 of the present embodiment showed an example in which an oblique traveling of the sheet paper 201 is corrected by using guide members (guide members 51) and movable guide members (movable guide members 52). The printer according to the present disclosure is, however, not limited to one including movable guide members. In other words, the printer 100, depending on its use, may not be provided with movable guide members (movable guide members 51), when an oblique traveling of the sheet paper 201 is sufficiently corrected by only guide members (guide members 51).

The printer 100 of the present embodiment is a dye-sublimation thermal printer, but the printer according to the present disclosure is not limited to the dye-sublimation thermal printer. It may be another printing-type printer other than the dye-sublimation thermal printer.

In other words, the printer according to the present disclosure may be a thermal printer other than dye-sublimation thermal printers, a non-thermal printer, such as an inkjet printer, or any other printing-type printer.

The printer 100 of the present embodiment has been described as printing on both of the front and back surfaces of the sheet paper 201, but the printer according to the present disclosure may be a printer that prints on only one surface of the sheet paper.

The printer 100 of the present embodiment is a printer that can print on the long roll paper 202 as well as on the sheet paper 201 pre-cut to a predetermined length, but the printer according to the present disclosure may be a printer that prints only on sheet paper, that is, one not capable of accommodating roll paper.

1. A printer comprising:
a transport path that a sheet paper passes therethrough;
a drive roller that is configured to send the sheet paper along the transport path, the drive roller being provided in an upstream region in a sending direction of the sheet paper of the transport path;
a downstream roller that is provided downstream in the sending direction of the transport path, the downstream roller being configured to restrain the sheet paper that has passed through the transport path; and
a pair of guide members that are disposed outside of both side edges of the sheet paper passing through the transport path to guide the sheet paper by limiting positions of both side edges of the sheet paper,
wherein each of the pair of guide members comprises a first portion positioned upstream in the sending direction and a second portion positioned downstream in the sending direction,
wherein a spacing between the pair of guide members is wider than a width of the paper at sections of the first portions closest to the drive roller, narrows gradually in the sending direction of the paper, becomes equal to the width of the sheet paper at sections of the first portions closest to the second portions, and remains equal to the width of the sheet paper at the second portions,
wherein, when an area between the drive roller and the second portions is halved into a first region upstream in the sending direction and a second region downstream in the sending direction, the sections of the first portions closest to the drive roller are positioned in the first region,
wherein the transport path comprises a space extending in a thickness direction of the sheet paper, such that the space accommodates a bent portion of the sheet paper in a mountain-like raised state between a front end portion of the sheet paper, whose direction has been corrected due to a limitation by the second portions, and a rear end portion of the sheet paper, which is restricted by the drive roller.

2. The printer according to claim 1, further comprising:
a retracting member that is configured to retract the drive roller to a position where it does not contact the sheet paper in a state in which a front end of the sheet paper in the sending direction has reached the second portions;
a movable guide member that is provided between the drive roller and the guide members to be movable from a position away from both side edges of the sheet paper to a position in contact with the both side edges thereof; and
a moving member that is configured to move the movable guide member in the movable range in a state in which the drive roller is retracted.

3. The printer according to claim 2, further comprising an adjusting mechanism that is configured to limit and adjust a position of a movement of the movable guide member to a side where the movable guide member contacts the both side edges of the sheet paper, within the movable range of the movable guide member.

4. The printer according to claim 2, wherein the retracting member and the moving member are integrally formed, such that the retraction of the drive roller to the position not in contact with the sheet paper is interlocked with the movement of the movable guide member to the position in contact with the both side edges, respectively.

5. The printer according to claim 2, wherein a position of the movable guide member in contact with the both side edges of the sheet paper is set as a position disposed on extended lines of the second portions.

6. The printer according to claim 4, wherein the printer is configured to print both surfaces of the sheet paper,
wherein the transport path, where the guide members are provided, is a pathway that allows the sheet paper to pass through when printing on a first one of the surfaces of the sheet paper and also when printing on a second one of the surfaces after finishing the printing on the first one of the surfaces of the sheet paper.

7. The printer according to claim 6, wherein the transport path, where the guide members are provided, comprises two of:
a pathway that allows the sheet paper to pass through when printing on the first surface and when printing on the second surface; and
a printing downstream path that allows the sheet paper to pass therethrough after printing on the first surface and after printing on the second surface.

8. The printer according to claim 2, wherein the moving member is configured to move the movable guide member to a position that is in contact with the both side edges, respectively, in a state in which a sending of the sheet paper is stopped.

9. The printer according to claim 8, wherein the moving member is configured to conduct, more than one time, an operation to move the movable guide member from a position away from the both side edges to a position in contact with the both side edges, respectively, in a state in which the sending of the sheet paper is stopped.
